(19) United States
(12) Patent Application Publication
(10) Pub. No.: US 2016/0188363 A1
(43) Pub. Date: Jun. 30, 2016

(54) METHOD, APPARATUS, AND DEVICE FOR MANAGING TASKS IN MULTI-TASK INTERFACE

(71) Applicant: ALIBABA GROUP HOLDING LIMITED, Grand Cayman (KY)

(72) Inventors: Yongqiang Sun, Hangzhou (CN); Ruijie Li, Beijing (CN)

(73) Assignee: ALIBABA GROUP HOLDING LIMITED

(21) Appl. No.: 14/979,273

(22) Filed: Dec. 22, 2015

(30) Foreign Application Priority Data
Dec. 25, 2014 (CN) 201410827910.7

(51) Int. Cl. G06F 9/48

(52) U.S. Cl. CPC G06F 9/4843

(57) ABSTRACT

A method for managing a task in a terminal device is provided. The method includes displaying a multi-task interface. The multi-task interface includes one or more task interfaces, where at least one of the task interfaces includes a task presenting area and a task operation area, and the task operation area includes an operating element for performing a function of the task. The method may further include, based on a user selection of the operating element in the task operation area, running an application corresponding to the task and executing an operation corresponding to the operating element.

### CROSS-REFERENCE TO RELATED APPLICATION

This application is based upon and claims priority to Chinese Patent Application No. 201410827910.7, filed Dec. 25, 2014, the entire contents of which are incorporated herein by reference.

### TECHNICAL FIELD

The present application relates to the technical field of terminal devices and, more particularly, to a method, an apparatus, and a terminal device for managing tasks in a multi-task interface.

### BACKGROUND

With the development of terminal devices such as smart phones and tablets, an increased number of applications (“APP”) have been developed for users. Frequently, a user uses a number of applications on the same terminal device during a certain time period and switches tasks among the applications.

A multi-task interface on a terminal device is designed for allowing users to view recent operation history, quickly close one or more application task operations, view internal memory usage, and quickly switch between two applications. Conventionally, in a multi-task interface of a terminal device, if a user desires to use a function in a certain application that was recently enabled (e.g., pausing/playing, previous/next functions of music playing), the user would need to click an icon or a thumbnail of this task to restart the task, and enter the corresponding application to control the corresponding function. The multi-task interface does not provide the user an ability to control a function of a task until the corresponding application is restarted. Consequently, a longer operation time may be required for the user to control a function in a recently used application, which results in a degraded user experience.

### SUMMARY

The present disclosure provides a method for managing a task in a terminal device. Consistent with some embodiments, the method includes displaying a multi-task interface. The multi-task interface includes one or more task interfaces, where at least one of the task interfaces includes a task presenting area and a task operation area, and the task operation area includes an operating element for performing a function of the task. The method may further include, based on a user selection of the operating element in the task operation area, running an application corresponding to the task and executing an operation corresponding to the operating element.

Consistent with some embodiments, this disclosure provides an apparatus for managing a task in a terminal device. The apparatus includes a displaying unit configured to display a multi-task interface. The multi-task interface includes one or more task interfaces, where at least one of the task interfaces includes a task presenting area and a task operation area, and the task operation area includes an operating element for performing a function of the task. The apparatus may further include a receiving unit configured to receive a user selection of the operating element in the task operation area. The apparatus may further include a first processing unit configured to, based on the user selection of the operating element, run an application corresponding to the task and execute an operation corresponding to the operating element. Consistent with some embodiments, this disclosure provides a terminal device. The terminal device includes a display, a processor, and a computer-readable storage medium storing instructions executable by the processor. The processor may be configured to execute the instructions to cause the terminal device to generate a multi-task interface. The multi-task interface includes one or more task interfaces, where at least one of the task interfaces includes a task presenting area and a task operation area, and the task operation area includes an operating element for performing a function of a task. The processor may be further configured to execute the instructions to cause the terminal device to, based on a user selection of the operating element in the task operation area, run an application corresponding to the task and execute an operation corresponding to the operating element.

Consistent with some embodiments, this disclosure provides a non-transitory computer-readable storage medium having stored therein instructions. When executed by a processor in a device, the instructions cause the device to display a multi-task interface. The multi-task interface includes one or more task interfaces, where at least one of the task interfaces includes a task presenting area and a task operation area, and the task operation area includes an operating element for performing a function of the task. The instructions may further cause the device to, based on a user selection of the operating element in the task operation area, run an application corresponding to the task and executing an operation corresponding to the operating element.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of an exemplary method for managing tasks in a multi-task interface, consistent with some embodiments of this disclosure.

FIGS. 2a-2c are schematic diagrams illustrating multi-task interfaces, consistent with some embodiments of this disclosure.

FIG. 3 is a flowchart of another exemplary method for managing tasks in a multi-task interface, consistent with some embodiments of this disclosure.

FIG. 4 is a flowchart of another exemplary method for managing tasks in a multi-task interface, consistent with some embodiments of this disclosure.

FIG. 5 is a block diagram of an exemplary apparatus for managing tasks in a multi-task interface, consistent with some embodiments of this disclosure.

FIG. 6 is a block diagram of another exemplary apparatus for managing tasks in a multi-task interface, consistent with some embodiments of this disclosure.

FIG. 7 is a block diagram of an exemplary terminal device, consistent with some embodiments of this disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

Consistent with some embodiments of this disclosure, a method and an apparatus for managing tasks in a multi-task interface is provided. The method and apparatus described in this disclosure may be applied to various types of terminal devices that can offer a multi-task interface, such as smart phones, tablets (pads), smart wear devices, etc. In the following description, a smart phone is used as an example for illustration. The disclosed embodiments, however, are not intended to be limited to a smart phone, and may be applied to other types of terminal devices without departing the scope of the present disclosure.

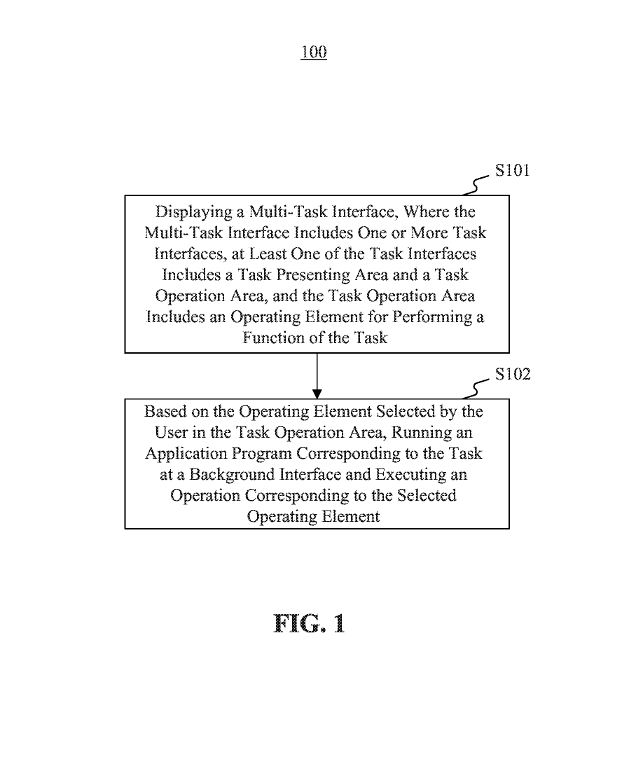

FIG. 1 is a flowchart of an exemplary method 100 for managing tasks in a multi-task interface, consistent with some embodiments of this disclosure. The exemplary method 100 may be performed by a terminal device. Referring to FIG. 1, the method 100 includes the following steps.

In step S101, the terminal device displays a multi-task interface. The multi-task interface includes one or more task interfaces, where at least one of the task interfaces includes a task presenting area and a task operation area, and the task operation area includes an operating element for performing a function of the task.

In the present disclosure, a multi-task interface refers to an interface for presenting relevant information about a plurality of recently enabled application tasks, such as in a manner of a list. The multi-task interfaces presented on various terminal devices may be different. For example, in some terminal devices, the multi-task interface only presents icons and names of the applications, while in other terminal devices, the multi-task interface presents icons, names of the applications, thumbnail of the task view, etc.

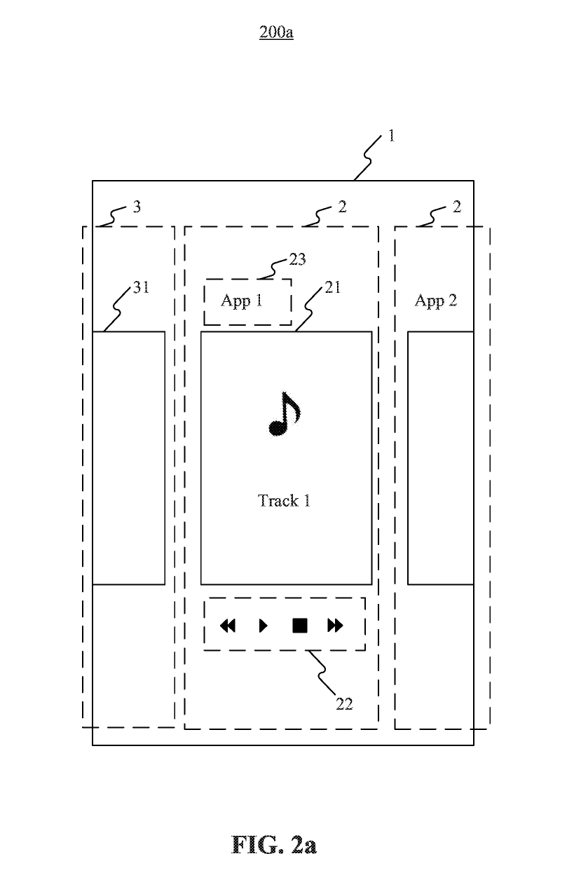

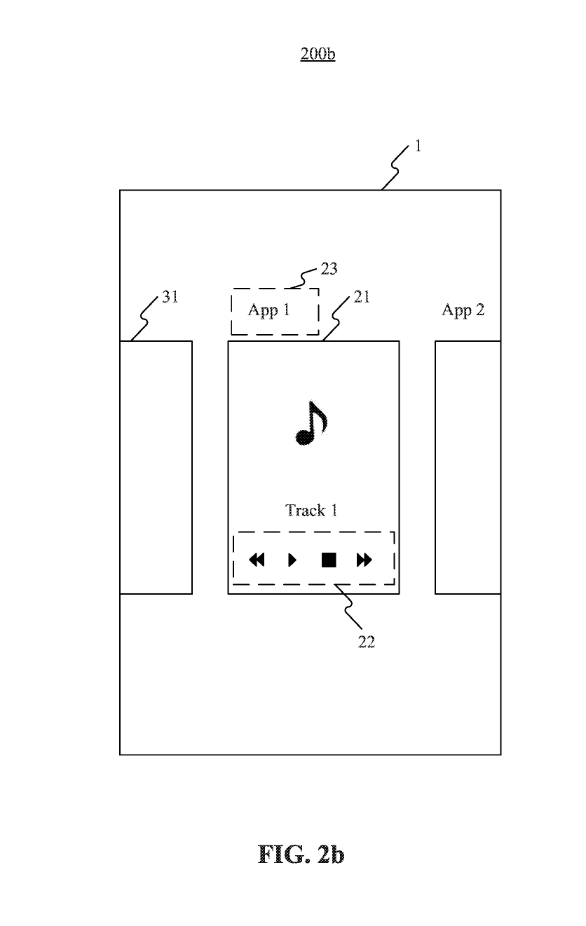

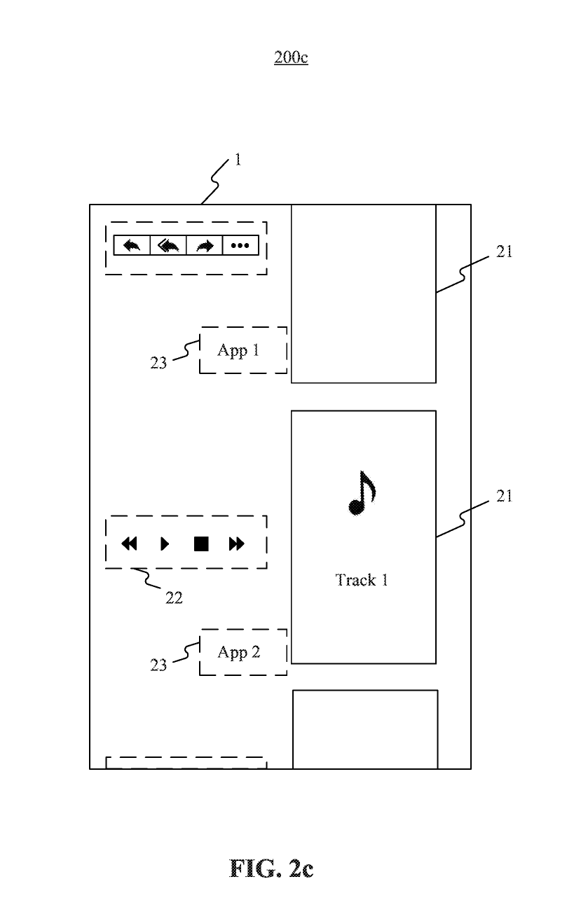

FIG. 2a is a schematic diagram 200a illustrating a multi-task interface, consistent with some embodiments of this disclosure. Referring to FIG. 2a, a multi-task interface 1 includes a task interface 2 and a home screen interface 3.

The task interface 2 includes a task presenting area 21, a task operation area 22, and an application icon or name presenting area 23. The task presenting area 21 includes a thumbnail of a task view. The thumbnail of a task view may include a thumbnail of the last interface image frame executed by the application corresponding to the task. The application icon or name presenting area 23 includes an application icon and/or name of the task. The task operation area 22 includes at least one operating element (e.g., an operation button). For example, as shown in FIG. 2a, the task operation area 22 may include Play [symbol] , Stop ▪, Previous [symbol] , and Next [symbol] , or other operating elements.

As shown in FIG. 2a, the application icon or name presenting area 23 may be located within a surrounding area that does not overlap with the task presenting area 21. Alternatively, the application icon or name presenting area 23 may be located within a surrounding area overlapping with the task presenting area 21.

The home screen interface 3 includes a thumbnail 31 of a home screen, which may be a first thumbnail displayed by the multi-task interface 1. In some embodiments, the thumbnail 31 of the home screen may be a thumbnail of the last interface image frame displayed by the home screen, before entering the multi-task interface.

As shown in FIG. 2a, the task interface 2 and the home screen interface 3 may be placed at different horizontal positions in the multi-task interface 1. When the user slides the task interface 2 or the home screen interface 3 in a left or right direction, the task interface 2 or the home screen interface 3 may be caused to move to the left or right direction correspondingly.

FIG. 2b is a schematic diagram 200b illustrating another multi-task interface, consistent with some embodiments of this disclosure. As shown in FIG. 2b, the task operation area 22 may be embedded within the task presenting area 21. Alternatively, the task operation area 22 may be located surrounding the task presenting area 21.

FIG. 2c is a schematic diagram 200c illustrating another multi-task interface, consistent with some embodiments of this disclosure. As shown in FIG. 2c, the task interface 2 and the home screen interface 3 may also be placed at different vertical positions in the multi-task interface 1. When the user slides the task interface 2 or the home screen interface 3 in a up and down direction, the task interface 2 or the home screen interface 3 may be caused to move up and down correspondingly.

As shown in FIGS. 2a-2c, a task operation area may be added to a task presenting area, allowing a user to control a function of the application via the operating element in the task operation area. The task operation area may be included within an existing task interface or located near an existing task icon.

In the task operation area, operating elements corresponding to functions of the application may be included. For example, in an application for audio playing, operating elements of Play, Pause, Stop, Previous, Next, and so on may be included in the task operation area. As another example, in a messaging application or a phone application, operating elements such as Reply, Forward, Reply All, Call Back, and so on may be included, when there is an unread message in a text message service APP, a missed call in a phone APP, an unread email in an Email APP, or the like. As another example, in a social network application (such as Wechat, Weibo, and Laiwang), operating elements such as Like, Forward, and Comment may be included. In an application for video playing, operating elements such as Pause, Play, Stop, Fast Forward, and Fast Rewind may be added. Specifically, the multi-task interface of a terminal device adds corresponding operating elements depending upon different common functions owned by different applications.

In step S102, based on the operating element selected by the user in the task operation area, the terminal device runs an application program corresponding to the task at a background interface and executes an operation corresponding to the selected operating element. In this disclosure, running an application at a background interface refers to the process of running the corresponding application program and executing the operation corresponding to the operating element, without exiting the multi-task interface.

For example, in an application for audio playing, if the user clicks an operating element of Play in the task operation area, the terminal device may run the application of audio playing at the background interface and plays a corresponding audio, without exiting the currently displayed multi-task interface. Similarly, an operation of Pause or other operations may also be performed if the user clicks a corresponding operating element in the task operation area.

In some embodiments, after running the application corresponding to the task at the background interface and executing the operation corresponding to the selected operating element, the terminal device may update an execution result for executing the operation corresponding to the selected operating element in a corresponding task presenting interface of the multi-task interface. For example, a thumbnail of the task in the task presenting area may be updated, or an operating element in the task operation area may be updated, such as updating the operating element of “Play” into “Pause”, or updating the operating element of “Pause” into “Play”.

By including the task operation area in the multi-task interface, the method 100 allows a user to directly perform operations on the application, without first starting the application and then entering the corresponding application to perform corresponding operations. In doing so, the method 100 may result in reduced memory occupancy and decreased consumption of system resources in the terminal device, as well as reduced users' operation time and improved user experience.

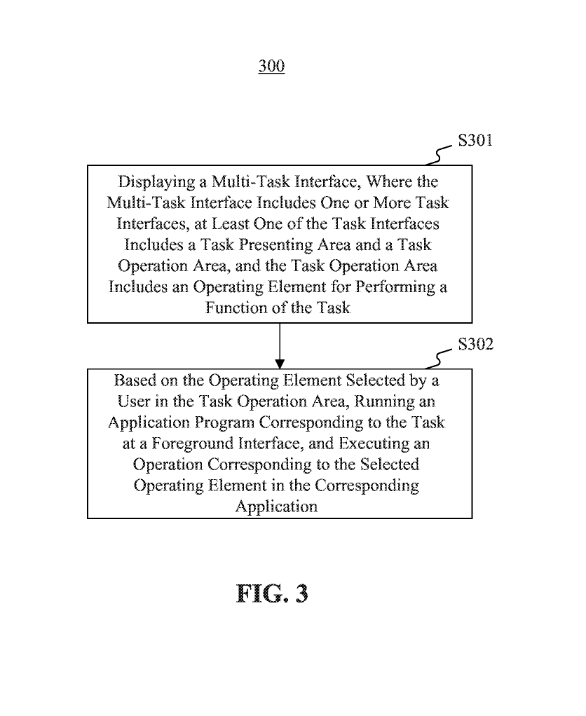

FIG. 3 is a flowchart of another exemplary method 300 for managing tasks in a multi-task interface, consistent with some embodiments of this disclosure. The exemplary method 300 may be performed by a terminal device. Referring to FIG. 3, the method 300 includes the following steps.

In step S301, the terminal device displays a multi-task interface. The multi-task interface includes one or more task interfaces, where at least one of the task interfaces includes a task presenting area and a task operation area, and the task operation area includes an operating element for performing a function of the task.

In step S302, based on the operating element selected by a user in the task operation area, the terminal device runs an application program corresponding to the task at a foreground interface, and executes an operation corresponding to the selected operating element in the corresponding application.

In the method 300, when a terminal device receives a selection of an operating element in the task operation area by a user, the terminal device directly starts and runs the application corresponding to the task, and executes an operation corresponding to the selected operating element in the application. For example, in an application for video playing, when a user desires to play a video in a full screen mode, the user may click the operating element of Play in the task operation area of the multi-task interface, and after receiving the user selection, the terminal device may start and run the application and play the video in a full screen mode. In doing so, user operation time and as system interruption may be reduced.

In a multi-task interface, operating elements corresponding to different applications may be implemented by using methods described in step S102 or step S302, depending upon the function to be achieved by the specific application. For example, for some functions that can run at the background interface, such as the functions of audio playing, step S102 may be implemented to run the function at the background interface. For other functions that may not achieve desired effects if running at the background interface, such as an application for video playing or various game applications, step S302 may be implemented at a foreground interface to enter the corresponding application and performing the corresponding function.

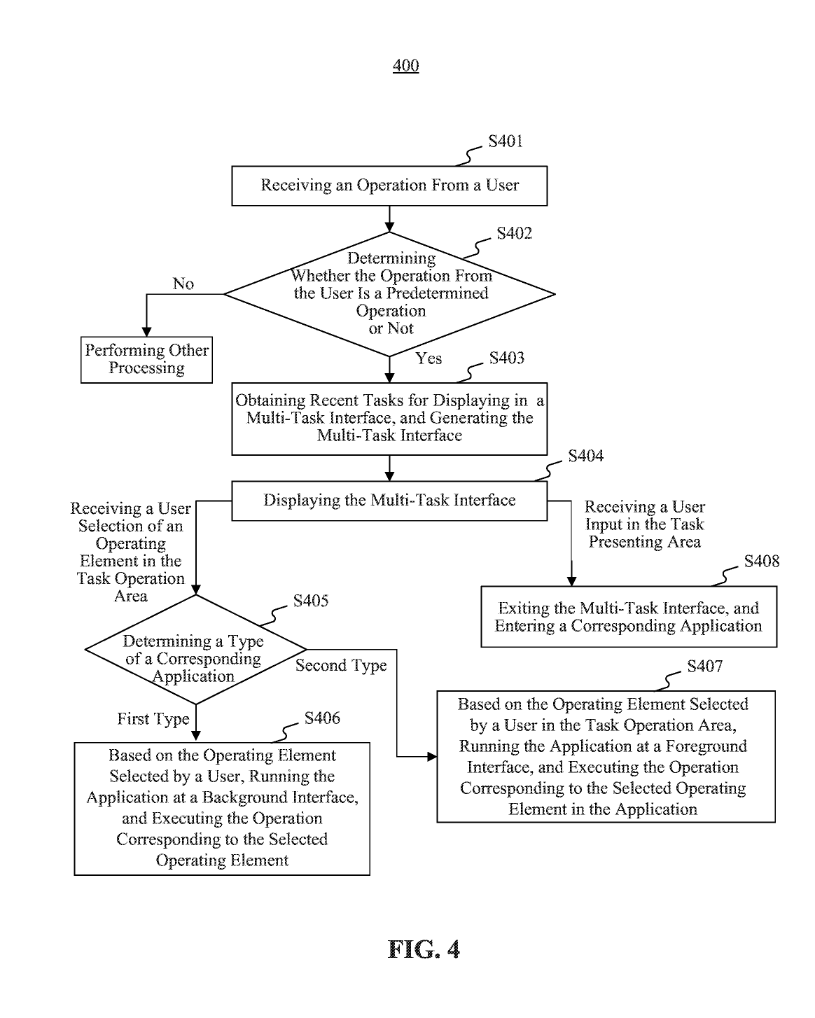

FIG. 4 is a flowchart of another exemplary method 400 for managing tasks in a multi-task interface, consistent with some embodiments of this disclosure. The exemplary method 400 may be performed by a terminal device. Referring to FIG. 4, the method 400 includes the following steps.

In step S401, the terminal device receives an operation from a user.

In step S402, the terminal device determines whether the operation from the user is a predetermined operation or not. If yes, the terminal device proceeds to step S403. If the operation from the user is not a predetermined operation, the terminal device performs other processing.

The predetermined operation may include, for example, pressing and holding Home button on a home page, double clicking Home button, double clicking Home icon displayed on a screen, clicking a combination of buttons on the screen, sequentially clicking a series of buttons on the screen based on a prompt on the screen, performing a preset gesture operation on the screen, and so on.

The multi-task interface may be triggered based on a predetermined user operation set by the terminal device. For example, the multi-task interface may be accessed by double clicking a home button of a smart phone.

In step S403, the terminal device obtains recent tasks for displaying in a multi-task interface and generates the multi-task interface.

The multi-task interface includes one or more task interfaces, in which at least one of the task interfaces includes a task presenting area and a task operation area, and the task operation area includes an operating element for performing a function of the task.

In some embodiments, step S403 may include the following sub-steps.

In sub-step S4031, the terminal device may obtain a list of the recent tasks.

Before accessing the multi-task interface, a user may have started a plurality of applications and performed various tasks. The terminal device may obtain a list of such recent tasks. The list may include information of the recent tasks, such as application names, application package names, and so on.

In sub-step S4032, based on application package names in the list, the terminal device may identify for each of the application package names whether a corresponding task operation area interface exists. If there is an existing task operation area corresponding to the application package name, the terminal device proceeds to sub-step S4033. If there is no existing task operation area corresponding to the application package name, the terminal device proceeds to sub-step S4034.

The task operation area interface refers to an interface for presenting various operating elements in the task operation area, which allows various applications to present an operating element or a sequence of operating elements in a certain form. Each application may have its own task operation area interface. The terminal device may store the task operation area interface of each application into a database according to application names or application package names, and so on. When an application is used by a recent task, and needs to be included in the multi-task interface, the terminal device may retrieve the corresponding task operation area interface from the database based on, for example, the application package name.

In sub-step S4033, the terminal device may include the existing task operation area interface in a corresponding task interface in the multi-task interface.

In sub-step S4034, the terminal device may generate a task operation area interface, and include the task operation area interface in the corresponding task interface in the multi-task interface.

If the database does not include a task operation area interface corresponding to the application name or application package name, the terminal device may generate one or more operating elements directed to frequently used functions of the application based on the application features. For certain applications, if it is not appropriate to generate the operating elements, the corresponding task interface may include no task operation area in the multi-task interface.

In step S404, the terminal device displays the multi-task interface.

In step S405, when receiving a user selection of an operating element in the task operation area, the terminal device determines a type of an application corresponding to the selected operating element. If the application belongs to a first type, the terminal device proceeds to step S406, and if the application belongs to a second type, the terminal device proceeds to step S407.

The first type refers to a type of applications that corresponding functions may be running at the background interface. For example, in an application for audio playing, functions such as Play or Pause may be running at the background interface of the terminal device. Thus, the application for audio playing belongs to the first type. As another example, in a social network application (such as Weibo), the functions of Like or Forward with respect to a certain message may be running at the background interface as well. Thus, the social network application belongs to the first type if the Like or Forward function is selected by the user.

The second type refers to a type of applications that may not achieve desired effects if corresponding functions run at the background interface. For example, in an application for video playing, a function of Play may not achieve desired effects if the function runs at the background interface of the terminal device, where the user cannot watch corresponding pictures or can only view pictures in a small size. Thus, the application for video playing belongs to the second type. As another example, in a social network application (such as Weibo), a function of Comment generally requires the user to input a comment at a specific position of the application. Thus, the social network application belongs to the second type if the Comment function is selected by the user. In some implementations, the terminal device may pop up a dialog box for the user to input a comment, and in this scenario, the social network application may belong to the first type.

In step S406, based on the operating element selected by a user in the task operation area, the terminal device runs the application corresponding to the task at a background interface, and executes the operation corresponding to the selected operating element. Step S406 may be implemented in a similar manner as step S102 described above in connection with FIG. 1, which is not repeated herein.

In step S407, based on the operating element selected by a user in the task operation area, the terminal device runs an application corresponding to the task at a foreground interface, and executes the operation corresponding to the selected operating element in the application. Step S407 may be implemented in a similar manner as step S302 described above in connection with FIG. 2, which is not repeated herein.

In step S408, when receiving a user input on the task presenting area, the terminal device exits the multi-task interface, and enters an application corresponding to the task presenting area.

If the user clicks the task presenting area, instead of the operating element in the task operation area, it may indicate that the user intends to enter an application corresponding to the task. Thus, the terminal device exits the multi-task interface, and enters a corresponding application of the task presenting area.

In some embodiments, the operating element in the task operation area may include a Lock button. When receiving a user selection of the Lock button, the terminal device may update a status of the corresponding task interface into a locked status, in which the task interface may not be removed by the user. Furthermore, after updating the status of the corresponding task interface a locked status, the terminal device may replace the Lock button with an Unlock button. When receiving a user selection of the Unlock button, the terminal device may update the status of the corresponding task interface into an unlocked status, in which the task interface may be removed by the user.

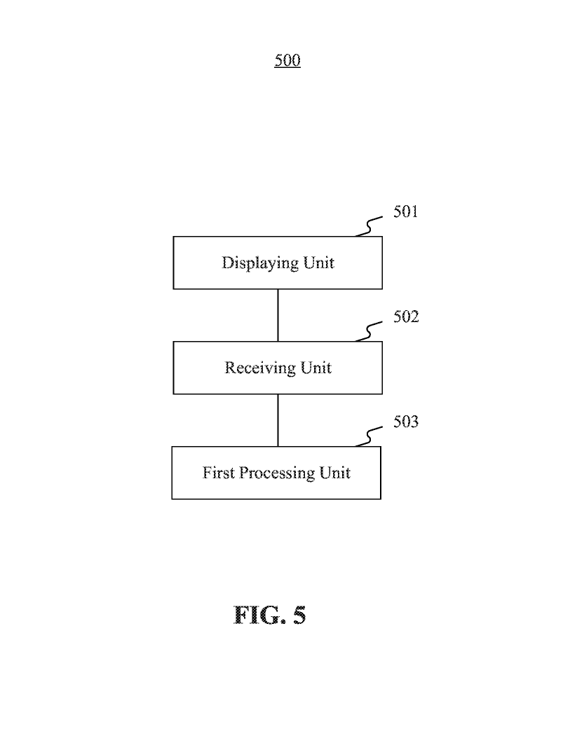

FIG. 5 is a block diagram of an exemplary apparatus 500 for managing tasks in a multi-task interface, consistent with some embodiments of this disclosure. The exemplary apparatus 500 may be implemented in a terminal device. Referring to FIG. 5, the apparatus 500 includes a displaying unit 501, a receiving unit 502, and a first processing unit 503.

The displaying unit 501 is configured to display a multi-task interface. The multi-task interface includes one or more task interfaces, in which at least one of the task interfaces includes a task presenting area and a task operation area, and the task operation area includes an operating element for performing a function of the task.

The receiving unit 502 is configured to receive operation information that a user selects an operating element in the task operation area displayed by the displaying unit 501.

Based on the selected operating element received by the receiving unit 502, the first processing unit 503 may be configured to run a corresponding application at a background interface, and execute an operation corresponding to the selected operating element. Alternatively, the first processing unit 503 may be configured to run an application corresponding to the task at a foreground interface, and execute an operation corresponding to the selected operating element in the application.

In some embodiments, after running the application corresponding to the task at the background interface and executing the operation corresponding to the selected operating element, the first processing unit 503 may be further configured to update an execution result for executing the operation in the task presenting interface of the multi-task interface.

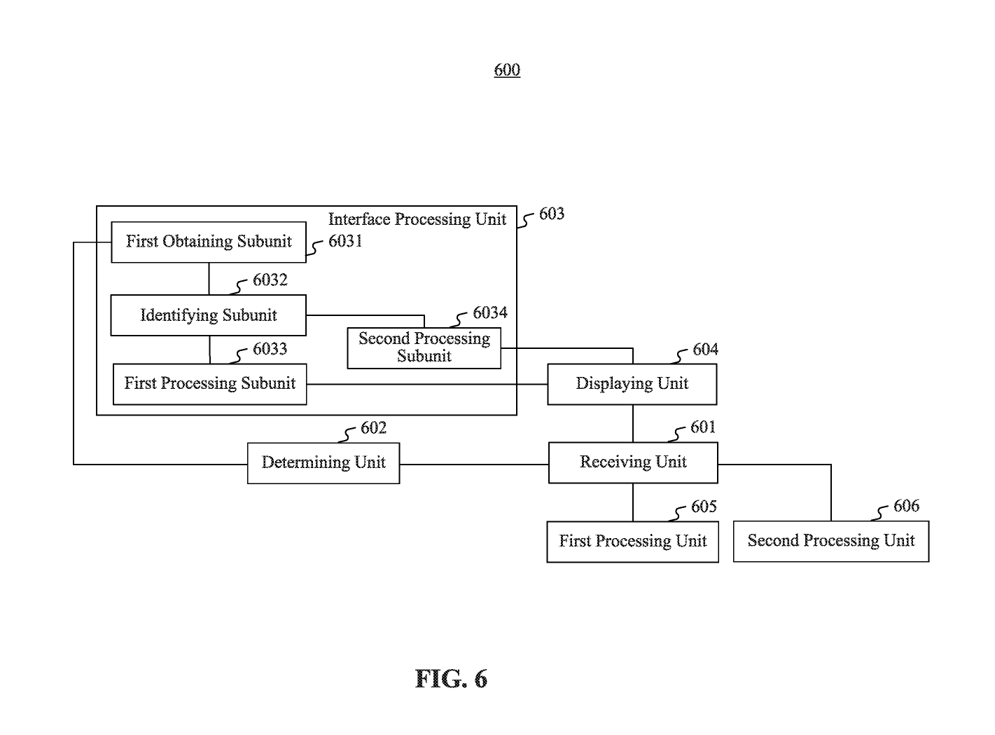

FIG. 6 is a block diagram of another exemplary apparatus 600 for managing tasks in a multi-task interface, consistent with some embodiments of this disclosure. The exemplary apparatus 600 may be implemented in a terminal device. Referring to FIG. 6, the apparatus 600 includes a receiving unit 601, a determining unit 602, an interface processing unit 603, a displaying unit 604, a first processing unit 605, and a second processing unit 606.

The receiving unit 601 is configured to receive an operation from a user.

The determining unit 602 is configured to determine whether the user's operation received by the receiving unit 601 is a predetermined operation or not. The predetermined operation may include, for example, pressing and holding Home button on a home page, double clicking Home button, double clicking Home icon displayed on a screen, clicking a combination of buttons on the screen, sequentially clicking a series of buttons on the screen based on a prompt on the screen, performing a preset gesture operation on the screen, and so on.

When the determining unit 602 determines that the user's operation is a predetermined operation, the interface processing unit 603 is configured to obtain recent tasks for displaying in a multi-task interface, and generate the multi-task interface to be displayed by the displaying unit 604.

The displaying unit 604 is configured to display the multi-task interface.

The multi-task interface includes one or more task interfaces, in which at least one of the task interfaces includes a task presenting area and a task operation area, and the task operation area includes an operating element for performing a function of on the task.

When the receiving unit 601 receives the operation information that the user selects an operating element in the task operation area presented by the display unit 604, the first processing unit 605 is configured to run an application corresponding to the task at a background interface and execute an operation corresponding to the selected operating element. Alternatively, the first processing unit 605 is configured to run an application corresponding to the task at a foreground interface and execute an operation corresponding to the selected operating element in the application, based on the selected operating element received by the receiving unit 601.

When the receiving unit 601 receives operation information that the user operates the task presenting area, the second processing unit 606 is configured to exit the multi-task interface and enter an application corresponding to the task presenting area.

In some embodiments, the interface processing unit 603 includes a first obtaining subunit 6031, an identifying subunit 6032, a first processing subunit 6033, and a second processing subunit 6034.

The first obtaining subunit 6031 is configured to obtain a list of recent tasks.

Based on application package names in the list obtained by the first obtaining subunit 6031, the identifying subunit 6032 is configured to identify whether a corresponding task operation area interface exists for each of the application package names.

When the identifying subunit 6032 identifies that there is an existing task operation area corresponding to the application package name, the first processing subunit 6033 is configured to include the existing task operation area interface in the corresponding task interface of the multi-task interface.

When the identifying subunit 6032 identifies that there is no existing task operation area corresponding to the application package name, the second processing subunit 6034 is configured to generate a task operation area interface, and include the task operation area interface in the corresponding task interface of the multi-task interface.

In some embodiments, the operating element of the task operation area includes a Lock button. When the receiving unit 601 receives an operation that the user selects the Lock button, the first processing unit 605 may be configured to update a status of the task interface corresponding to the task operation area to a locked status, in which the task interface may not be deleted. Furthermore, after updating the status of the task interface to the locked status, the first processing unit 605 may be configured to further replace the Lock button in the task operation area with an Unlock button. When the receiving unit 601 receives an operation that the user selects the Unlock button, the first processing unit 605 may be configured to update the status of the corresponding task interface into an unlocked status, in which the task interface may be deleted.

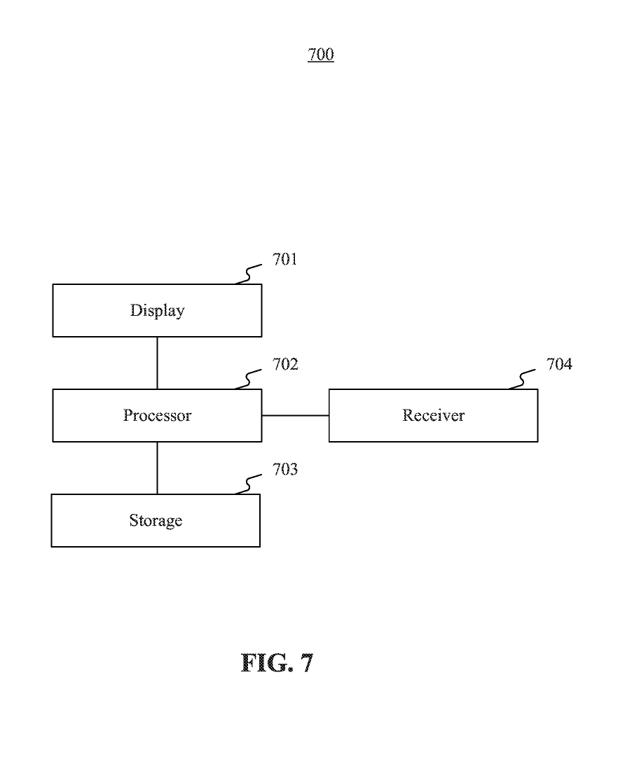

FIG. 7 is a block diagram of an exemplary terminal device 700, consistent with some embodiments of this disclosure. The terminal device 700 may execute all or a part of the steps in the above described methods. Referring to FIG. 7, the terminal device 700 includes a display 701, a processor 702, a storage 703, and a receiver 704. The terminal device may also include other components not shown in FIG. 7.

The storage 703 may include a non-transitory computer-readable storage medium, for example, a non-volatile storage (for example, a hard disk drive) and a flash memory, which is configured to store software programs and device drivers. The software program may include various functional modules of the methods described above. The device drivers may include network or interface drivers.

The receiver 704 is configured to interact with users, and receive an operation from the users. For example, the receiver 704 may be an input device such as a touch screen, a mouse, a keyboard, and so on.

The storage 703 may be configured to store a multi-task interface. When the multi-task interface is executed by the processor 702, the multi-task interface is displayed on a displaying area of the display 701. The multi-task interface includes one or more task interfaces, in which the at least one task interface includes a task presenting area and a task operation area, and the task operation area includes an operating element for performing a function of the task. When the receiver 704 receives a user selection of an operating element in the task operation area, the terminal device 700 runs an application corresponding to the task at a background interface and executes an operation corresponding to the selected operating element. Alternatively, the terminal device 700 runs an application corresponding to the task at a foreground interface and executes the operation corresponding to the selected operating element in the application, based on the operating element selected by the user in the task operation area. When the receiver 704 receives operation information that the user operates on the task presenting area, the terminal device 700 exits the multi-task interface, and enters the corresponding application.

In exemplary embodiments, a non-transitory computer-readable storage medium including instructions is also provided, and the instructions may be executed by a device (such as a terminal device, a personal computer, or the like), for performing the above-described methods. For example, the non-transitory computer-readable storage medium may be read-only memory (ROM), random access memory (RAM), Compact Disc Read-Only Memory (CD-ROM), magnetic tape, floppy disk, and optical data storage device, etc. Examples of RAM include Phase Change Random Access Memory (PRAM), Static Random Access Memory (SRAM), Dynamic Random Access Memory (DRAM), and other types of RAM.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

One of ordinary skill in the art will understand that the above described embodiments can be implemented by hardware, or software (program codes), or a combination of hardware and software. If implemented by software, it may be stored in the above-described computer-readable media. The software, when executed by the processor can perform the disclosed methods. The computing units and the other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for managing a task in a terminal device, comprising:
displaying a multi-task interface, wherein the multi-task interface comprises one or more task interfaces, at least one of the task interfaces includes a task presenting area and a task operation area, and the task operation area includes an operating element for performing a function of the task; and
based on a user selection of the operating element in the task operation area, running an application corresponding to the task and executing an operation corresponding to the operating element.

2. The method of claim 1, wherein the application runs at a background interface of the terminal device or at a foreground interface of the terminal device, after the user selection of the operating element.

3. The method of claim 1, further comprising:
receiving a user operation;
determining whether the user operation is a predetermined operation; and
when it is determined that the operation from the user is the predetermined operation, obtaining one or more recent tasks for displaying in the multi-task interface, and generating the multi-task interface.

4. The method of claim 3, wherein obtaining one or more recent tasks for displaying in the multi-task interface comprises:
obtaining a list of the recent tasks, the list including one or more application package names corresponding to the recent tasks;
for each of the application package names in the list, identifying whether a corresponding task operation area interface exists;
if a corresponding task operation area interface exists, including the corresponding task operation area interface in a corresponding task interface of the multi-task interface; and
if a corresponding task operation area interface does not exist, generating the corresponding task operation area interface, and including the corresponding task operation area interface in a corresponding task interface of the multi-task interface.

5. The method of claim 3, wherein the predetermined operation comprises one or more of: pressing and holding a Home button, double clicking the Home button, double clicking a Home icon displayed on a screen, clicking a combination of buttons on a screen, sequentially clicking a series of buttons on the screen based on a prompt on the screen, and performing a preset gesture operation on the screen.

6. The method of claim 1, wherein the operating element of the task operation area comprises a Lock button, the method further comprising:
when receiving a selection of the Lock button by the user, causing a task interface corresponding to the task operation area to be in a locked status, wherein the task interface in the locked status is not removable from the multi-task interface by the user.

7. The method of claim 6, further comprising:
after causing the task interface corresponding to the task operation area to be in the locked status, replacing the Lock button with an Unlock button;
when receiving a selection of the Unlock button by the user, causing a task interface corresponding to the task operation area to be in an unlocked status, wherein the task interface in the unlocked status is removable from the multi-task interface by the user.

8. The method of claim 1, wherein the application runs at a background interface of the terminal device, the method further comprising:
after running the application corresponding to the task at the background interface and executing the operation corresponding to the selected operating element, updating an execution result for executing the operation in the at least one of the task interfaces of the multi-task interface.

9. The method of claim 1, further comprising:
when receiving a user input in the task presenting area, exiting the multi-task interface, and entering an application corresponding to the task presenting area.

10. An apparatus for managing a task in a terminal device, comprising:
a displaying unit configured to display a multi-task interface, wherein the multi-task interface comprises one or more task interfaces, at least one of the task interfaces includes a task presenting area and a task operation area, and the task operation area includes an operating element for performing a function of the task;
a receiving unit configured to receive a user selection of the operating element in the task operation area; and
a first processing unit configured to, based on the user selection of the operating element, run an application corresponding to the task and execute an operation corresponding to the operating element.

11. The apparatus according to claim 10, wherein the first processing unit is configured to run the application at a background interface of the terminal device or at a foreground interface of the terminal device.

12. The apparatus according to claim 10, wherein the receiving unit is configured to receive a user operation before the displaying unit displays the multi-task interface, the apparatus further comprising:
a determining unit configured to determine whether the user operation is a predetermined operation; and
an interface processing unit configured to, when the determining unit determines that the operation from the user is the predetermined operation, obtain one or more recent tasks for displaying in the multi-task interface, and generate the multi-task interface for the displaying unit to display.

13. The apparatus according to claim 12, wherein the interface processing unit comprises:
a first obtaining subunit configured to obtain a list of the recent tasks, the list including one or more application package names corresponding to the recent tasks;
an identifying subunit configured to, for each of the application package names in the list, identify whether a corresponding task operation area interface exists;
a first processing subunit configured to include the corresponding task operation area interface in a corresponding task interface of the multi-task interface, if a corresponding task operation area interface exists; and
a second processing subunit configured to generate the corresponding task operation area interface, and include the corresponding task operation area interface in a corresponding task interface of the multi-task interface, if a corresponding task operation area interface does not exist.

14. The apparatus according to claim 12, wherein the predetermined operation comprises one or more of: pressing and holding a Home button, double clicking the Home button, double clicking a Home icon displayed on a screen, clicking a combination of buttons on a screen, sequentially clicking a series of buttons on the screen based on a prompt on the screen, and performing a preset gesture operation on the screen.

15. The apparatus according to claim 10, wherein the operating element of the task operation area comprises a Lock button, and wherein the first processing unit is configured to:
when the receiving unit receives a selection of the Lock button by the user, cause a task interface corresponding to the task operation area to be in a locked status, wherein the task interface in the locked status is not removable from the multi-task interface by the user.

16. The apparatus according to claim 15, wherein the first processing unit is configured to:
after causing the task interface corresponding to the task operation area to be in the locked status, replace the Lock button with an Unlock button; and
when the receiving unit receives a selection of the Unlock button by the user, cause a task interface corresponding to the task operation area to be in an unlocked status, wherein the task interface in the unlocked status is removable from the multi-task interface by the user.

17. The apparatus according to claim 10, wherein the first processing unit is configured to:
run the application corresponding to the task at a background interface of the terminal device; and
after running the application corresponding to the task at the background interface and executing the operation corresponding to the selected operating element, update an execution result for executing the operation in the at least one of the task interfaces of the multi-task interface.

18. The apparatus according to claim 10, further comprising:
a second processing unit configured to, when the receiving unit receives a user input in the task presenting area, exit the multi-task interface, and enter an application corresponding to the task presenting area.

19. A terminal device, comprising:
a display;
a processor; and
a computer-readable storage medium storing instructions executable by the processor;
wherein the processor is configured to execute the instructions to cause the terminal device to:
generate a multi-task interface, wherein the multi-task interface comprises one or more task interfaces, at least one of the task interfaces includes a task presenting area and a task operation area, and the task operation area includes an operating element for performing a function of a task; and
based on a user selection of the operating element in the task operation area, run an application corresponding to the task and execute an operation corresponding to the operating element.

20. The terminal device according to claim 19, wherein the processor is further configured to execute instructions stored in the computer-readable storage medium to cause the terminal device to: when receiving a user input in the task presenting area, exit the multi-task interface, and enter an application corresponding to the task presenting area.

21. A non-transitory computer-readable storage medium having stored therein instructions that, when executed by a processor in a device, cause the device to:
display a multi-task interface, wherein the multi-task interface comprises one or more task interfaces, at least one of the task interfaces includes a task presenting area and a task operation area, and the task operation area includes an operating element for performing a function of the task; and
based on a user selection of the operating element in the task operation area, run an application corresponding to the task and executing an operation corresponding to the operating element.
